(19) United States
(12) Patent Application Publication
(10) Pub. No.: US 2009/0125230 A1
(43) Pub. Date: May 14, 2009

(54) SYSTEM AND METHOD FOR ENABLING LOCATION-DEPENDENT VALUE EXCHANGE AND OBJECT OF INTEREST IDENTIFICATION

(76) Inventor: Todd Frederic Sullivan, Ann Arbor, MI (US)

Correspondence Address: BURNS & LEVINSON, LLP, 125 SUMMER STREET, BOSTON, MA, 02110, US

(21) Appl. No.: 12/271,297

(22) Filed: Nov. 14, 2008

Related U.S. Application Data
(60) Provisional application No. 60/987,891, filed on Nov. 14, 2007.

(51) Int. Cl. G01C 21/00; G06F 17/40; G06F 17/30

(52) U.S. Cl. 701/207; 701/300; 707/104.1; 707/E17.018; 707/E17.044

(57) ABSTRACT

A system and method for enhancing the value of social networking is disclosed wherein information broadcast/disclosed by a social network member includes information about a social network member's temporal geographic location or availability to facilitate, for example, value exchange and object of interest location.

### CROSS REFERENCE TO RELATED APPLICATIONS

The present application claims priority to U.S. Provisional Application No. 60/987,891 filed Nov. 14, 2007, entitled METHOD FOR ENABLING SOCIAL NETWORKING AND VALUE EXCHANGE FOR PARTICIPATING USERS WITHIN A GEOGRAPHIC AREA which is incorporated herein in its entirety by reference.

### BACKGROUND

The system and method of the present embodiment relate generally to the integration of networking, value exchange, and object tracking, and in particular, to social networking, value exchange, and object tracking.

Networking has traditionally entailed meeting with other individuals and exchanging business cards etc. in order to establish a personal or a business relationship. Social networking is a variant of traditional networking where members of a social network share information about each other and are able to communicate and share information and media through various means. The FACEBOOK® social network is an example of one such social network that is comprised of millions of registered members in various locales. Many social networks rely on the Internet for communication but any wired or wireless communication system is suitable. The benefits to members of social networks include entertainment, forming personal relationships, forming business relationships and creative/expressive outlets. The usefulness of social networks is limited in some circumstances by the inability for users/members of a social network to sort or select their members by certain relevance criteria, such as temporal geographic proximity. There is a need for members of a social network to communicate via multiple networks such as the Internet, SMS networks and cellular communication networks in a layered anonymous manner for privacy and security. There is a further need to verify that members of a social network are in fact within a particular reported locale and/or on a particular local network. What is still further needed is technology to verify the location of the participants as a requirement for participation. What is even still further needed is a means to provide directions to social network members if voice and visual recognition are not practical. What is even still further needed is a means to negotiate a value exchange such as a financial transaction through a social network.

Currently, mobile location-based services, which focus on tracking people, can be permission-based and can require that “tracked” people are members of the service. These requirements can limit the usefulness of these services to tracking friends and coworkers or to mobile dating. What is needed is a system and method that make use of member-contributed content to track non-members. Further, current location identification can be limited to the accuracy of a member's mobile device, for example, handsets can typically to resolve within 300 meters for network-based tracking (e.g. triangulation) and 150 meters for global positioning system (GPS) tracking. What is needed is a system and method for location identification in which a user who observes an object of interest can refine the location of the object of interest by providing location information such as, for example, “Tom Cruise is eating a scone in the back of Starbucks”, to other users.

### SUMMARY

The needs set forth above as well as further and other needs and advantages are addressed by the embodiments set forth below.

The system and method of the present embodiment provide members of a network such as, for example, a social network, to exchange value, and allow members of the network to trade information with each other about a third party, where the information can be verified. The present teachings provide a service that allows members of the network who are in the same place at the same time, determined by a device or tag, such as, for example, but not limited to, a mobile device or tag, (1) to be identified to each other, for example temporarily anonymously, based on compatible user-created needs/features/profiles, and (2) to negotiate a value exchange.

Examples can include, but are not limited to including, situations in which the members are (1) a potential buyer and a potential seller of tickets who are identified to each other at a stadium; (2) a software developer at a coffee shop who is job-searching and a potential employer patronizing the coffee shop; (3) travelers who desire to trade seats on an airplane (for example, but not limited to, a window seat for an aisle); (4) travelers who desire to find a ride/cab to share; and (5) a vendor and a potential customer where the vendor would like to send a commercial promotion for a special store sale to the customer in the vicinity of the vendor's establishment. The service of the present embodiment can involve exchanges that can be viewed as trades and can allow individuals who may not know each other but who share a feature such as, for example, a common location at a certain time, to exchange value, optionally anonymously, through the service of the present embodiment.

Information can also be exchanged. For example, if one member observes an object of interest such as a celebrity, the member can provide that information to other members who are similarly situated in time and location. The member can remain anonymous or can be attributed through the service of the present embodiment. Additionally there can be a real-time updating based on member input of people and objects of interest to a database or catalogue that is managed by the system of the present embodiment. The member can request to be alerted about groups of people and objects of interest such as, for example, but not limited to, pro hockey players, sex offenders, and certain types of automobiles, based on many factors including, but not limited to, the location of the object of interest and the location of the member with respect to the object of interest. Members can contribute to the database when they observe objects of interest. Through member input, the database can be updated with the location information of the object of interest by an automatic association of the member's device/tag with a location and the object of interest. In addition to updating the databases, users may update users directly based on similar location and time being established for sharing data, exchanging value, etc. among users and between users and the object of interest.

Since the member's device/tag can identify the member's location and the time of day, the system of the present embodiment can associate an observation of an object of interest within a visible distance of the location of the object of interest at a given time. When multiple members input the same observation at a similar time and location, a verification can occur that can further strengthen the reliability of the location and time data associated with the object of interest. These member inputs can update a database, and the system of the present embodiment can provide real-time notifications to members interested in the whereabouts of the objects of interest that are known to the database. Members can control which real-time updates they receive based on, for example, any parameters tracked in the database, such as, for example, location of the member, location of the object of interest, and distance from the object of interest. Further, members can update each other and/or the database with new objects of interest that can be visually identified, such as, for example, a quarterback of a local high school football team. A member could update information about an object of interest to another member or to the database, along with, for example, a photograph.

The system and method of the present embodiment can accommodate significant motion by the member's device, for example, if the member's device is in an automobile, by disabling location based services such as, for example, GPS on the member's device, such as, for example, a mobile device, a laptop, or a desktop. Thus, the system and method of the present embodiment can enhance the value of social networking because the information that is disclosed/broadcast by a network member can include information, for example, about the member's temporal geographic location or availability on a particular localized network, for example, a Wi-Fi hot spot, and where the information disclosed/broadcast can be confirmed by independent means. In the present embodiment, location and proximity of types of people, such as, for example registered sex offenders, can be communicated to members of the network based on the members' temporal geographic location, which can be verified, and the members' preferences. Using the system and method of the present embodiment, members can expand and exploit social network graphs created by commercially-available social networks such as, for example, the FACEBOOK® social network, by enabling partially anonymized introductions, conversations, or value exchange between strangers who are in the same place, at the same time.

Operation of the system and method of the present embodiment can begin, but is not limited to beginning, in a social network's application platform as an application that can provide a pseudo-anonymous connection among individuals who may not know each other, but who have a common interest such as, for example, meeting socially or exchanging value based on their common location at a common specific point in time. The system and method of the present embodiment can maximize a member's chances for communicating with strangers while mitigating the inevitable awkwardness in most initial interactions. The system and method can reveal temporary markets when and where no markets may have been otherwise available.

Examples of use of the present embodiment follow. In the following scenarios, a member of a social network, that includes application code implementing the system and method of the present embodiment, activates the application code and transmits a message including the current time and the member's location. (1) The member observes a person she would like to meet. The member can describe to the system physical characteristics that could coincide with profile characteristics that the observed person would have entered if the person were executing the system of the present embodiment such as, for example, gender, skin color hair color, height, and laptop model. The system and method of the present embodiment can locate people in the social network who are currently co-located with the operating member, and can deliver a message to the observed person that can allow the observed person to, for example, view the operating member's profile and respond to the operating member if interested in communicating. The observed person would only receive the operating member's message if the observed person activates the application and if the observed person's characteristics for accepting communication coincide with the operating member's characteristics. (2) The member is a potential employee who needs work. The potential employee can activate the system and method of the present embodiment while patronizing an establishment, for example, a coffee shop. The potential employee can broadcast a message to members of the network in proximity to the potential employee where the message can include information about the potential employee and information about what he or she needs. Other members in the same location at the same time who have also activated the system and method of the present embodiment, and who have indicated to the system and method a willingness to view a message such as the message of the potential employee, will see the potential employee's message and other associated information. The potential employee may not have access to information about whom, if anyone, is viewing the disclosed/broadcast message. (3) The member is a business traveler who can use the system and method of the present embodiment to send a message to other members by means of, for example, the hotel Wi-Fi network, where the message can indicate the traveler's location and interest in finding a similarly situated companion for an outing such as, for example, dinner, theater, a nightclub, or a bar. (4) The member is a potential buyer of a ticket to an event, for example, a sporting event. The member is at the venue and can provide to the system and method of the present embodiment the member's general location through a device such as, for example, a mobile phone. Providing such information can make available to the member a network of buyers and sellers of tickets at the venue for the event. Identities of the buyers and sellers can remain anonymous until a match is made. (5) The member has preferred activities such as, for example, tennis. The member can make his or her tennis ability and rankings available and thus attract a tennis partner who has an interest in playing tennis with the member. (6) The member is a consumer who may want to accept advertisements based on his or her location and preferences. (7) The member is a traveler who might, for example, need transportation, or might like to ride-share, or might like to swap seats on, for example, a train or plane. There are countless examples of opportunities to exchange value or communicate with a stranger. The system and method of the present embodiment meet the need in today's society to facilitate these communications in a private and temporarily anonymous way until both parties are comfortable with the communication or value exchange.

The present embodiment can automatically identify an object of interest as well as its location (geo tagging) based on an artifact such as, for example, a photograph, using recognition software. Because of this capability, the present embodiment can accommodate such applications as real time user tracking of, for example, criminal offenders such as sex offenders. The nationally published database of registered sex offenders' home locations can be published to registered users based on the users' locations. In addition, the present embodiment can allow users to spot offenders and report their locations for the benefit of the community. This spotting and reporting allows users to receive alerts when offenders are physically within proximity of users which is a benefit over simply knowing home addresses.

The present embodiment can also accommodate the automatic disabling of location-based services when the user is in significant motion, such as when, for example, the user is in a moving vehicle, to inhibit the reporting of unnecessary data. Using time stamped photos in combination with location identifying technology such as, for example, but not limited to, GPS, cell tower triangulation, IP address, or wireless local area network (LAN), can allow for verification of real time tracking. Further, the present embodiment can accommodate location verification of objects of interest, in particular through the inclusion of artifact data such as, for example, but not limited to, photographic data, biographical data, a body of work, related products, and a message or communication from the object of interest and related links relevant to the object of interest. For example, camera-equipped mobile devices can capture an image of, for example, a sex offender, and can compare that image using conventional facial recognition software to verify the identify of the sex offender. Further an artifact such as a photograph could be submitted with a time and location stamp to create a history of movement of, for example, sex offenders, which could help law enforcement in apprehending the correct offenders post crime.

For example, a possible entry in a database of objects of interest can include data such as “Tom Cruise, photo, personal and professional background, list of movies with links to purchase them, recent news articles, a message from Tom, ‘thanks for checking in on me, but please respect my privacy as I am not signing autographs today’, link to e-mail Tom, link to Tom's website.” This information can be stored in an internal database or can be augmented by information such as, for example, RSS feeds from tabloid magazines, WIKIPEDIA®, Internet movie database (IMDb®), etc. In the present embodiment, the object of interest can communicate with users either one by one or to the group as a whole to define the relationship and future communication. The object of interest can also maintain anonymity in the present embodiment. For example, a fee could be charged to be removed from the database of the present embodiment. Conversely, a fee could be charged to be added to the database of the present embodiment. For example, a new actor wanting to establish some celebrity could be willing to pay the fee and be added to the database. The present embodiment can also accommodate automatic adding of objects of interest. For example, members of a community could update the database of the present embodiment when, for example, a new baseball player is selected for the major leagues and is now worth following. Users of the present embodiment can post comments to each other about a person of interest during a “sighting”, for example, “Tom is at Starbucks with wife Katie Holmes.”

For a better understanding of the present embodiments, together with other and further objects thereof, reference is made to the accompanying drawings and detailed description.

### DESCRIPTION OF THE SEVERAL VIEWS OF THE DRAWING

FIG. 1 is a schematic block diagram of the system of the present embodiment;

FIG. 2 is a schematic block diagram of an alternate embodiment of the system;

FIG. 3 is a schematic block diagram of exemplary components of the alternate embodiment;

FIG. 4 is a flowchart of the method of the present embodiment;

FIG. 5 is a flowchart of the method of an alternate embodiment; and

FIGS. 6-9 are exemplary display screen snapshots illustrating a sequence of screens that could be displayed to a user being in proximity to a particular object of interest.

### DETAILED DESCRIPTION

The present embodiments are now described more fully hereinafter with reference to the accompanying drawings. The following configuration description is presented for illustrative purposes only. Any computer configuration and architecture satisfying the speed and interface requirements herein described may be suitable for implementing the system and method of the present embodiments.

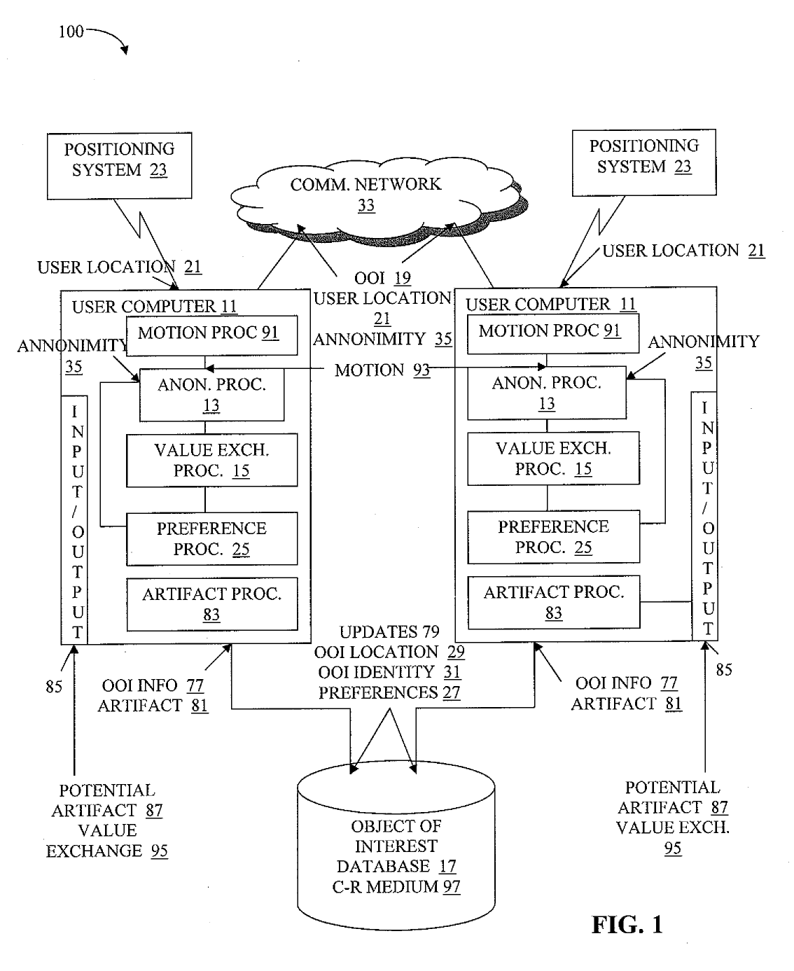

Referring now to FIG. 1, system 100 for identifying, in real-time, location 29 of observed object of interest 19, can include, but is not limited to including, positioning system 23 communicating user locations 21 through communications network 33 to user computer 11, which includes motion processor 91 interpreting historical user locations 21 to compute motion 93, anonymity processor 13 to receive and process anonymity 35, value exchange processor 15, preference processor 25, artifact processor 83, input/output processor 85, and object of interest database 17, located on, for example, computer-readable medium 97. Motion processor 91 can continuously and automatically establish user locations 21 through computer-aided positioning system 23, anonymity processor 13 can enable anonymity 35 for the users, and artifact processor 83 can execute in conjunction with positioning system 23 and input/output processor 85 to enable the users to identify observed object of interest 19 proximate to user locations 21. Preference processor 25 can enable the users to establish preferences 27 for receiving observed object of interest information 77 about observed object of interest 19 when the users are proximate to observed object of interest 19, and communications network 33 can enable the users to communicate with each other regarding observed object of interest location 29, where the communications can be based on preferences 27.

Continuing to refer to FIG. 1, motion processor 91 can enable the users to prepare updates 79 to observed object of interest location 29, and artifact processor 83 can enable the users to submit updates 79 to observed object of interest information 77. Motion processor 91 can verify observed object of interest location 29 based on updates 79. Artifact processor 83 can access a pre-stored artifact 81 potentially associated with observed object of interest 19, and can verify observed object of interest identity 31 by comparing pre-stored artifact 81 with potential artifact 87 associated with observed object of interest 19. Anonymity processor 13 can enable user-controlled relinquishing of anonymity 35. Motion processor 91 can detect when the user is in motion and can disable computer-aided positioning system 23 when motion 93 reaches a pre-determined threshold. Communications network 33 can enable observed object of interest 19 to communicate with the users. Anonymity processor can enable observed object of interest 19 to maintain anonymity 35 from the users. Artifact processor 83 can enable an object to be recognized as observed object of interest 19.

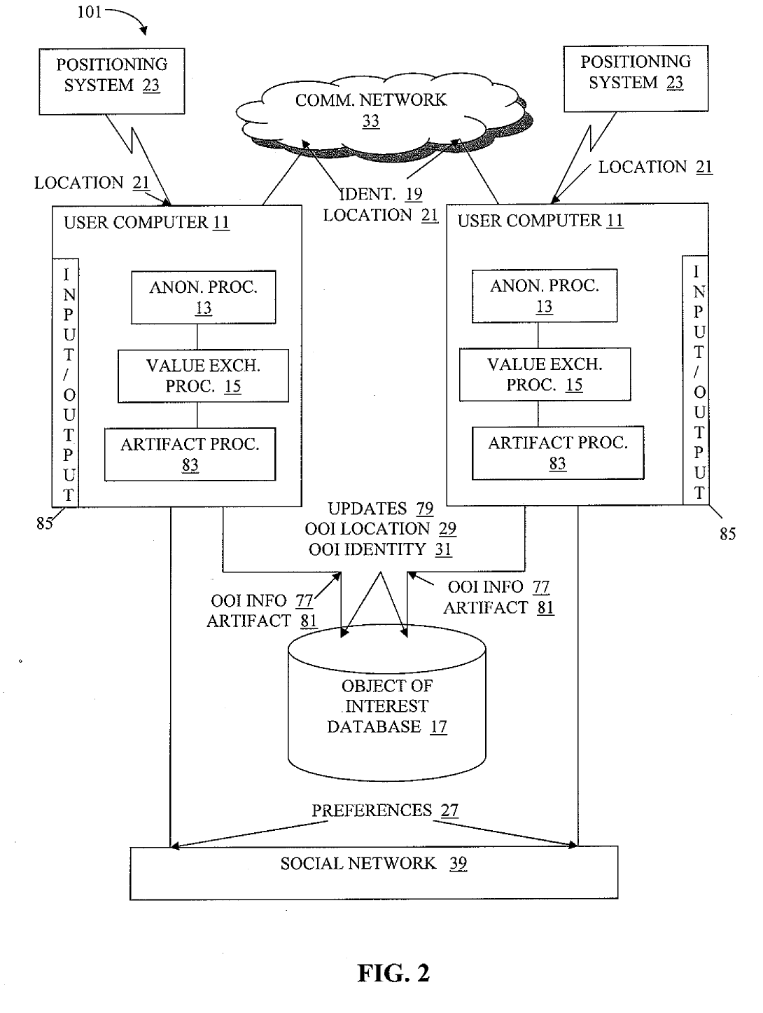

Referring now to FIG. 2, system 101 can include, but is not limited to including, most of the elements of system 100 having the functionality as described above, interfacing with conventional social network 39 which, among other things, manages preferences 27. An example of the use of system 101 follows.

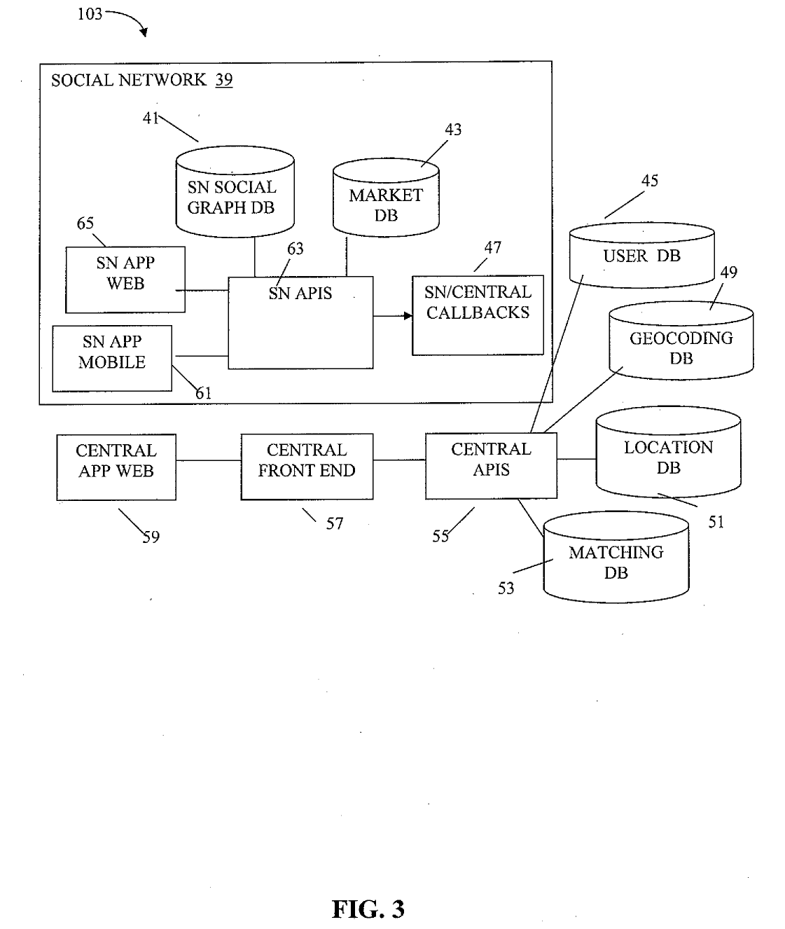

Referring now primarily to FIG. 3, system 103 (FIG. 3), an application of the present embodiment, can execute in the context of a social network 39 (FIGS. 2 and 3), for example, the FACEBOOK® social network environment. Social network 39 (FIG. 3) of system 103 (FIG. 3) can include, but is not limited to including, social network social graph database 41 (FIG. 3), market database 43 (FIG. 3), social network web application 65, social network mobile application 61 (FIG. 3), social network applications programming interfaces (APIs) 63 (FIG. 3), social network central callbacks 47 (FIG. 3), providing conventional social network services to a users recorded in user database 45 (FIG. 3). Central web application 59 (FIG. 3), central front end 57 (FIG. 3), and central APIs 55 (FIG. 3) provide interface functionality so that users can communicate with social network 39 (FIGS. 2 and 3). The present embodiment is not limited to a FACEBOOK® implementation, however, but can be implemented in the context of for example, but not limited to, an IPHONE®, ANDROID™, WINDOWS MOBILE®, and MYSPACE®, and can also be a stand alone web service that provides the functionality of the present embodiment on any computing device. Location technology is not necessary to participate as a user of the present embodiment because the user can manually input user location 21 (FIGS. 1 and 2), and can send and receive data based on the manual input. Object of interest database 17 (FIGS. 1 and 2) can store data about, for example, a member's preferences 27 (FIGS. 1 and 2) and privacy settings, or preferences 27 (FIGS. 1 and 2) can be part of a member's profile managed by conventional social network 39 (FIGS. 1 and 2). In addition, relevant data can be extracted from the member's profile that is a part of the commercial social network 39 (FIGS. 1 and 2), as well as the member's social graph stored on social network graph database 41 (FIGS. 1 and 2), for example, the member's friends. Still further, the member can describe his or her desired value exchange 95 (FIG. 1) and this information can be stored in object of interest database 17 (FIGS. 1 and 2), or can be communicated directly among users. Time and location, or locative data such as a WiFi network, can be recorded in object of interest database 17 (FIGS. 1 and 2). Additional data can be collected from various sources to augment the member's desired value exchange 95 (FIG. 1) and stored in object of interest database 17 (FIGS. 1 and 2), or communicated directly. The combination of these data can feed the matching service enabled by matching database 53 (FIG. 3). An implementation might use social network application programming interface 63 (FIG. 3) of commercial social network 39 (FIGS. 2 and 3), of social network web application 65 (FIG. 3), and of other tools to facilitate value exchange 95 (FIGS. 1 and 2). Using data from object of interest database 17 (FIGS. 1 and 2) that are relevant to the member, further data may be retrieved from a commercial locative database 51 (FIG. 3) or a commercial geocoding database 49 (FIG. 3) to determine the member's location. The matching service enabled by matching database 53 (FIG. 3) can use the member's location to determine a match between the member who is initiating the desired value exchange 95 (FIGS. 1 and 2) and other members or objects of interest, who should be notified about the potential value exchange 95 (FIGS. 1 and 2). The matching service can consider secondary characteristics of members or objects of interest who may be involved in the value exchange 95 (FIGS. 1 and 2) and can notify them. Members who meet privacy and communication preferences can be notified of the potential value exchange 95 (FIGS. 1 and 2), and can be provided with a process by which to take action with respect to the value exchange 95 (FIGS. 1 and 2).

Continuing to refer primarily to FIG. 3, integration between the FACEBOOK® social network and the application of the present embodiment can be facilitated in at least two ways. The application can have a presence on the FACEBOOK® social network XHTML website (m.facebook.com) in the form of profile boxes and canvas pages, and the application can leverage the FACEBOOK® social network small message service (SMS) to directly interact with members through text messaging. Members can interact with applications that they have installed as well as add new applications from both the XHTML site and via SMS. The FACEBOOK® platform for mobile (XHTML FBML) can allow the application to integrate with the FACEBOOK® website in profile boxes and canvas pages. The <fb:mobile> tag can provide integration into the mobile XHTML version of the FACEBOOK® web site (http://m.facebook.com). At the FACEBOOK® mobile site, XHTML Profile Pages, can feature a limited version of the member's profile page designed for optimized viewing on a mobile device. The application may integrate with this profile by use of the <fb:mobile> tag. When the FACEBOOK® social network evaluates a FBML profile, content inside the <fb:mobile> tag can be rendered exclusively on m.facebookcom. This content may not be displayed on the website. Further, profile content outside of the <fb:mobile> tag may not be displayed on the mobile site.

Continuing to refer primarily to FIG. 3, the FACEBOOK® social network can enable application developers using FBML to build XHTML Canvas Pages optimized for the mobile device by signaling when the mobile device may be in use and providing the option for the application developer to use an XHTML frame. In order to use an XHTML frame instead of a conventional FACEBOOK® frame, an application implementing canvas pages in FBML may wrap the canvas page FBML in opening and closing <fb:mobile> tags. The <fb:mobile> tag can be, for example, the outermost tag in the FBML markup. When this is specified, the mobile XHTML frame can be used, which is visually consistent with the m.facebook.com site. In order to help developers identify when a mobile device may be in use, the FACEBOOK® social network may optionally send an additional header with the canvas page request. When the FACEBOOK® social network recognizes a browser agent likely to be mobile, a POST parameter “fb_sig_mobile” is sent with a value of one. Control over which frame can be used is left up to the developer. The application may choose to ignore the fb_sig_mobile parameter, and the normal frame will be used. Similarly, applications can also be free to use the <fb:mobile> tag even when the FACEBOOK® social network has not identified the agent as a mobile device. According to XHTML best practices, in order to guarantee proper rendering on mobile devices with limited processing bandwidth capability and/or alternate browser implementations, content inside the <fb:mobile> tag can be limited to a subset of the full FBML markup language. Most notably, FACEBOOK® JavaScript (FBJS) and Mock Asynchronous JavaScript and XML (Mock AJAX) constructs can be made unavailable. The developer FBML test console can be used to test rendering of <fb:mobile> content by including the <fb:mobile> tag. The FACEBOOK® Platform for Mobile small message service (SMS) platform can provide methods for directly interacting with FACEBOOK® users through SMS interaction, including sending messages and responding to messages via text message. There are conventional opt-in processes available for receiving SMS messages. In order to enable SMS support, the application may direct the member to appropriate conventional tools such as can be found at, for example, http://www.facebook.com/authorize.php?api key=YOUR API KEY&v=1.0&ext perm=sms. If the member is not already registered for FACEBOOK® Mobile or the application, the request is cached and forwarded when the member validates the action.

Continuing to still further refer to FIG. 3, a member can send a query directly to the application by issuing a text message of the form :app_canvas_name <query> to the FBOOK shortcode (32665). In addition, if the application had previously sent a message and requested a session, any user response to that message will be forwarded to the application directly. This happens through a post method to the application's callback URL with the following parameters: fb_sig_sms-set to one to indicate an SMS callback; fb_sig_user is the user identification that triggered the callback; fb_sig_message is the message string stripped of the header; fb_sig_sms_sid is a the session id to be used if the application wishes to respond to the message (a session id is only unique per user identification to which it corresponds); fb_sig_sms new user is set to one if the member has just recently added the application through offline SMS. The application can be given a timeout of, for example, one minute in which to respond to the message, after which period the session can expire. Application generated messages, sms.canSend(uid uid), can be used to determine whether the member identified by “uid” has enabled SMS for this application. Status messages can be sent from the application to the member asynchronously, and an active session may not be required.

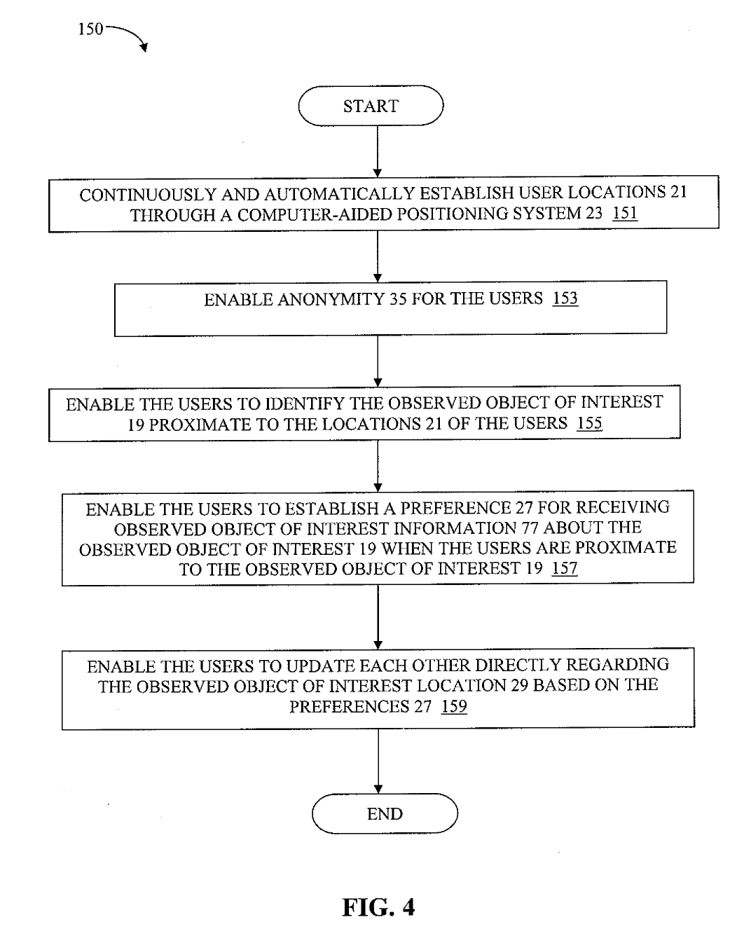

Referring now primarily to FIG. 4, method 150 for identifying in real-time the location 29 of observed object of interest 19 can include, but is not limited to including, the steps of continuously and automatically establishing 151 user locations 21 through computer-aided positioning system 23, enabling 153 anonymity 35 for the users, enabling 155 the users to identify observed object of interest 19 proximate to locations 21 of the users, enabling 157 the users to establish preference 27 for receiving observed object of interest information 77 about observed object of interest 19 when the users are proximate to observed object of interest 19, and enabling 159 the users to communicate with each other regarding observed object of interest location 29 based on preferences 27. Method 150 can optionally include the steps of enabling the users to update observed object of interest location 29 and observed object of interest information 77, and verifying observed object of interest location 29 based on updates 79. Method 150 can further optionally include the steps of accessing pre-stored artifact 81 potentially associated with observed object of interest 19, and verifying observed object of interest identity 31 by comparing pre-stored artifact 81 with potential artifact 87 associated with observed object of interest 19. Method 150 can still further optionally include the steps of enabling user-controlled relinquishing of anonymity 35, detecting when the user is in motion, and disabling computer-aided positioning system 23 when motion 93 reaches a pre-determined threshold. Method 150 can even still further include the steps of enabling observed object of interest 19 to communicate with the users, enabling observed object of interest 19 to maintain anonymity 35 from the users, enabling an object to be recognized as observed object of interest 19, and enabling value exchange 95 between the users and object of interest 19. For example, a user could exchange an autograph from a famous person for a donation to the charity of the famous person. The autograph can be, for example, a digital autograph that can be accepted by the user's computer, and can be used to verify the presence of object of interest 19, and can also be used as part of value exchange 95. Objects of interest 19, such as famous people, can request, through the present embodiment, value exchange 19 of financial remuneration for each intrusion into their privacy. If the present embodiment can create a culture of respecting the wishes of famous people, substantial value exchanges 95 (merchandise sales, charitable giving, etc.) could occur in concert with minimizing privacy intrusions on the famous people.

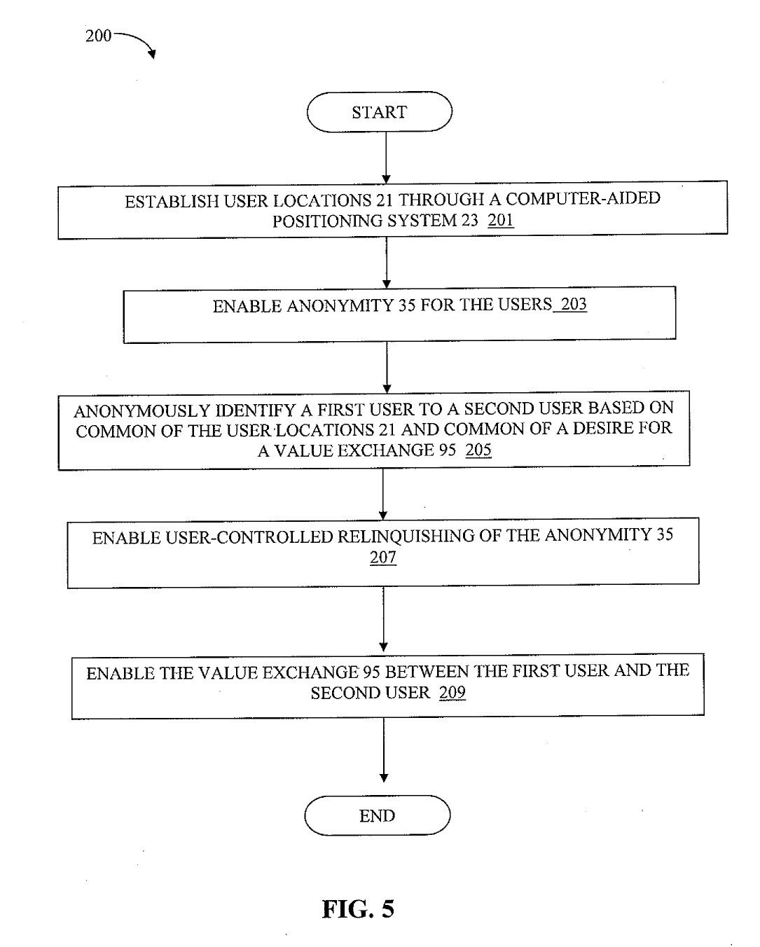

Referring now primarily to FIG. 5, method 200 for value exchange based on location including, but not limited to, the steps of establishing 201 user locations 21 through computer-aided positioning system 23, enabling 203 anonymity 35 for the users, anonymously identifying 205 a first user to a second user based on common of the user locations 21 and common of a desire for value exchange 95, enabling 207 user-controlled relinquishing of anonymity 35, and enabling 209 value exchange 95 between the first user and the second user. Value can be exchanged among, for example, members of a social network, or between a member of a social network and an object of interest.

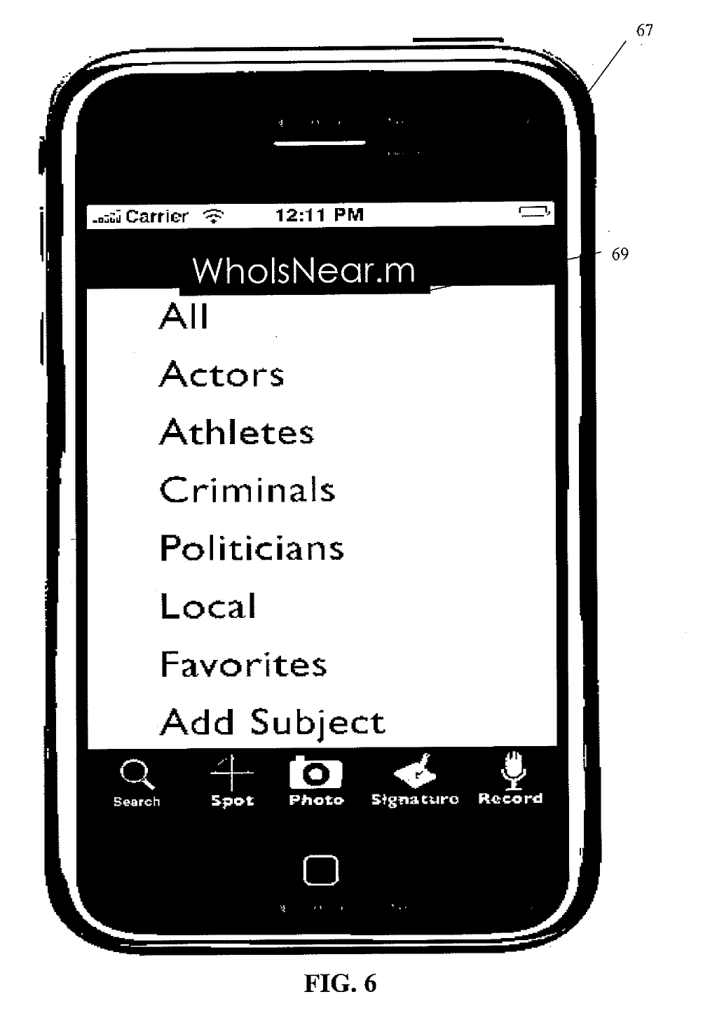

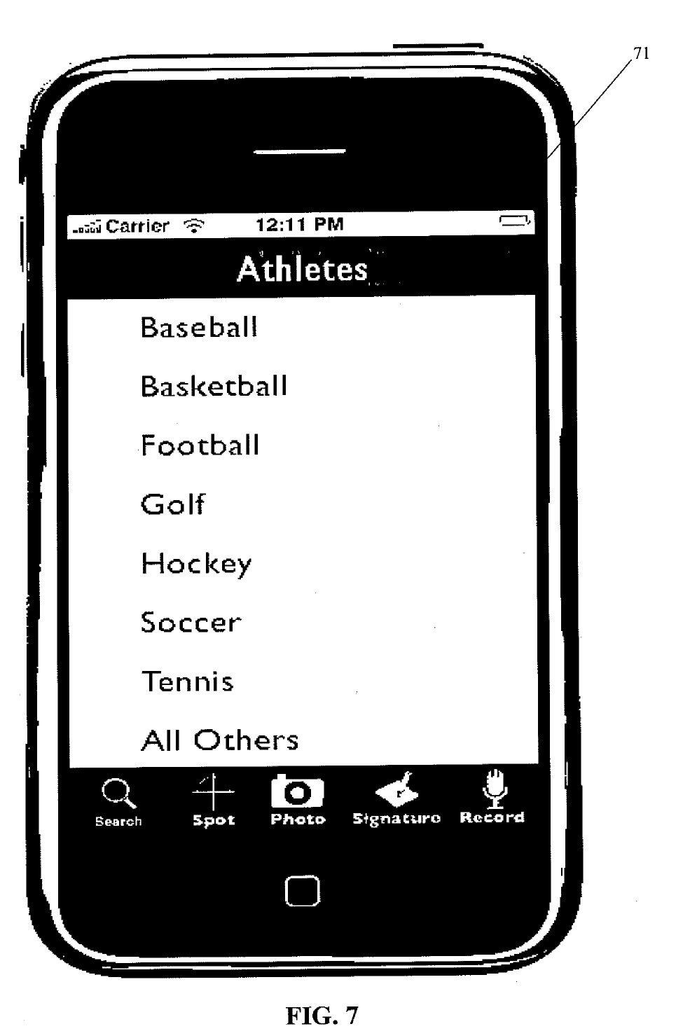

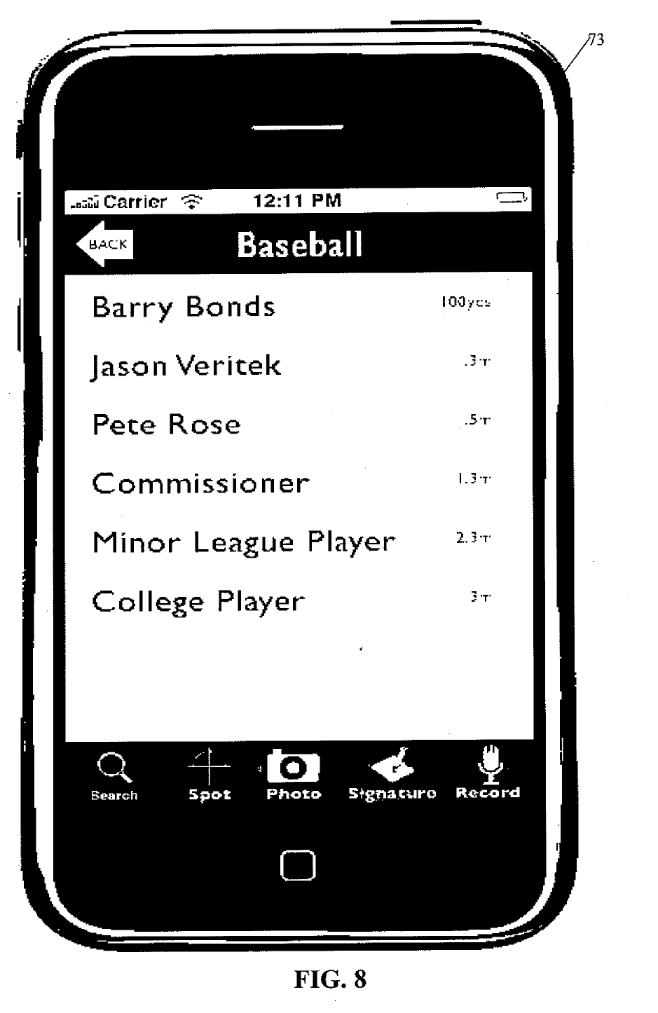

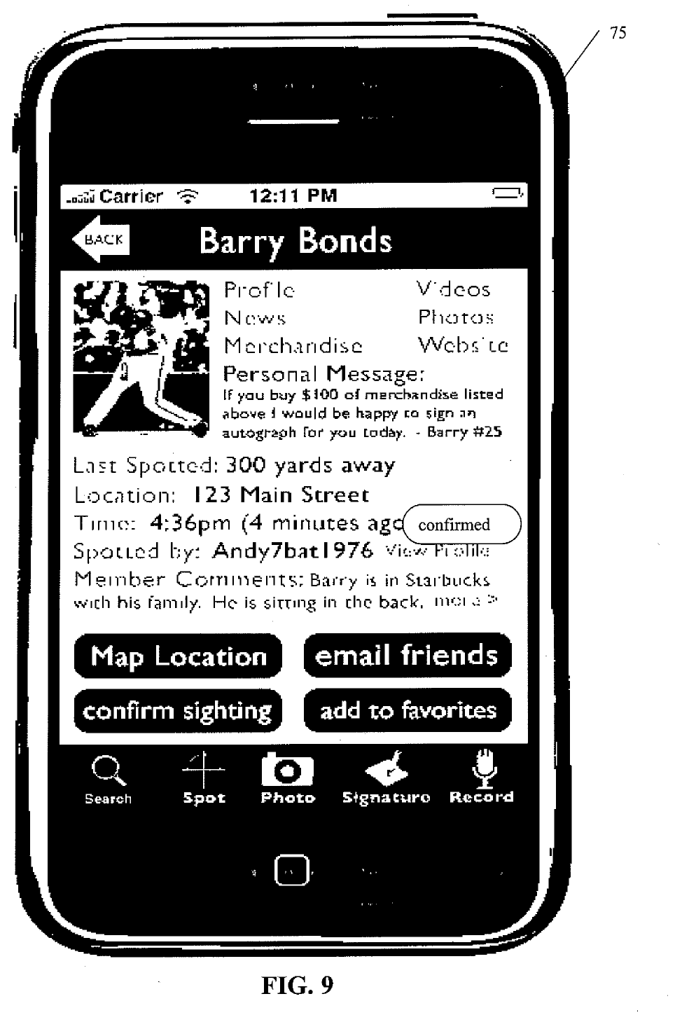

Referring now primarily to FIGS. 6-9, a sequence of screen shots illustrating the method of use of the present embodiment show whoisnear screen 67 that could be displayed to a user of system 100 (FIG. 1) who is looking for objects of interest 19 (FIGS. 1 and 2) in particular categories 69 (FIG. 6) that are near to the physical location of the user. If the user clicks on, for example, “athletes”, athletes screen 71 (FIG. 7) can be displayed, and the user may choose a sport. If the user clicks on, for example, “baseball”, baseball screen 73 (FIG. 8) can be displayed, and the user may choose an athlete from the sport of baseball who is found to be in physical proximity to the user. If the user chooses, for example, “barry bonds”, barry bonds screen 75 (FIG. 9) is shown, and the user may be presented with information about and communications from the chosen athlete.

Although the teachings have been described with respect to various embodiments, it should be realized these teachings are also capable of a wide variety of further and other embodiments.

What is claimed is:

1. A method for identifying in realtime the location of an observed object of interest comprising the steps of:
continuously and automatically establishing user locations through a computer-aided positioning system;
enabling anonymity for the users;
enabling the users to identify the observed object of interest proximate to the locations of the users;
enabling the users to establish a preference for receiving observed object of interest information about the observed object of interest when the users are proximate to the observed object of interest; and
enabling the users to update each other directly regarding the observed object of interest location based on the preferences.

2. The method as in claim 1 further comprising the step of:
enabling the users to update the observed object of interest location and the observed object of interest information in a database.

3. The method as in claim 2 further comprising the step of:
verifying the observed object of interest location based on the updates.

4. The method as in claim 1 further comprising the steps of:
accessing a pre-stored artifact potentially associated with the observed object of interest; and
verifying an observed object of interest identity by comparing the pre-stored artifact with a potential artifact associated with the observed object of interest.

5. The method as in claim 1 further comprising the step of:
enabling user-controlled relinquishing of the anonymity.

6. The method as in claim 1 further comprising the steps of:
detecting when the user is in motion; and
disabling the computer-aided positioning system when the motion reaches a pre-determined threshold.

7. The method as in claim 1 further comprising the step of:
enabling the observed object of interest to communicate with the users.

8. The method as in claim 1 further comprising the step of:
enabling the observed object of interest to maintain the anonymity from the users.

9. The method as in claim 1 further comprising the step of:
enabling an object to be recognized as the observed object of interest.

10. The method as in claim 1 further comprising the step of:
enabling a value exchange between the users and the object of interest.

11. A method for value exchange based on location comprising the steps of:
establishing user locations through a computer-aided positioning system;
enabling anonymity for the users;
anonymously identifying a first user to a second user based on common of the user locations and common of a desire for a value exchange;
enabling user-controlled relinquishing of the anonymity; and
enabling the value exchange between the first user and the second user.

12. A system for identifying in real-time the location of an observed object of interest comprising:
a motion processor continuously and automatically establishing user locations through a computer-aided positioning system;
an anonymity processor enabling anonymity for the users;
an artifact processor executing in conjunction with a positioning system and an input/output processor enabling the users to identify said observed object of interest proximate to said user locations;
a preference processor enabling the users to establish a preference for receiving observed object of interest information about said observed object of interest when the users are proximate to said observed object of interest; and
a communications network enabling the users to communicate with each other regarding said observed object of interest location based on said preferences.

13. The system as in claim 12 wherein said motion processor enables the users to prepare updates to said observed object of interest location and said artifact processor enables the users to submit said updates to said observed object of interest information.

14. The system as in claim 13 wherein said motion processor verifies said observed object of interest location based on said updates.

15. The system as in claim 12 wherein said artifact processor accesses a pre-stored artifact potentially associated with said observed object of interest, and verifies an observed object of interest identity by comparing said pre-stored artifact with a potential artifact 87 associated with said observed object of interest.

16. The system as in claim 12 wherein said anonymity processor enables user-controlled relinquishing of said anonymity.

17. The system as in claim 12 wherein said motion processor detects when the user is in motion and disables said computer-aided positioning system when said motion reaches a pre-determined threshold.

18. The system as in claim 12 wherein said communications network enables said observed object of interest to communicate with the users.

19. The system as in claim 12 wherein said anonymity processor enables said observed object of interest to maintain said anonymity from the users.

20. The system as in claim 12 wherein said artifact processor enables an object to be recognized as said observed object of interest.

21. A node in a communications network for carrying out the method of claim 1.

22. A communications network having at least one node for carrying out the method of claim 1.

22. A computer-readable medium having instructions for carrying out the method of claim 1.
